(19) United States
(12) Patent Application Publication
(10) Pub. No.: US 2025/0223435 A1
(43) Pub. Date: Jul. 10, 2025

(54) MODIFIED BIODEGRADABLE ELASTOMERS WITH IMPROVED RESIN COMPATIBILITY AND METHODS OF MANUFACTURE THEREOF

(71) Applicant: Erthos Inc., Mississauga (CA)

(72) Inventors: Hossein ABDOLI, Mississauga (CA); Nima ZARRINBAKHSH, Mississauga (CA); Emmanuel Olusegun OGUNSONA, Mississauga (CA); Shadi MESHKAT ALSADAT, Mississauga (CA); Devni Nayanathara ELAMALDENIYA, Mississauga (CA)

(21) Appl. No.: 18/404,468

(22) Filed: Jan. 4, 2024

(51) Int. Cl. C08L 67/04; C08G 63/08; C08J 3/00

(52) U.S. Cl. CPC C08L 67/04; C08G 63/08; C08J 3/005; C08J 2367/04; C08J 2467/02; C08L 2201/06; C08L 2205/025; C08L 2205/08

(57) ABSTRACT

The invention pertains to improving the compatibility between biodegradable polyester elastomers and biodegradable thermoplastic polymers through chemical modification of the elastomer for melt processing applications such as extrusion, batch mixing, and compression molding. The invention encompasses biodegradable polymer resins of a modified biodegradable polyester elastomer and at least one biodegradable thermoplastic polyester. The invention allows for tailored compatibility of the biodegradable elastomer with other biopolymers through chemical modifications during the synthesis process of the elastomer.

### FIELD OF INVENTION

The invention encompasses methods of enhancing the compatibility between biodegradable polyester elastomers with biodegradable thermoplastic polyesters, for example, in melt blending applications and the compositions and resins manufactured using these methods. The invention further encompasses compositions comprising biodegradable polyester elastomers and biodegradable thermoplastic polymers for melt processing applications, including, but not limited to, twin or single screw extrusion, batch mixing, and compression molding. The resulting resins exhibit improvement in mechanical properties including, but not limited to, tensile strength, Young's modulus, flexural strength, elongation at break, melt flow rate and impact energy.

### BACKGROUND OF THE INVENTION

The use of elastomers to target or impart specific properties to a polymer by blending is a well-known technique.

Recently, the focus has been on enhancing the characteristics of biopolymers, especially those that are more brittle such as polylactic acid (PLA) and polyhydroxyalkanoates, by the employment of elastomers.

This invention is useful for a variety of polymer processing applications where the use of non-biodegradable and non-biobased compatibilizers is restricted. Additional benefits of such methods are described herein.

### SUMMARY OF THE INVENTION

The invention encompasses melt-reprocessible, biodegradable modified polyester elastomers that exhibit improved compatibility when blended with biodegradable thermoplastic polyesters through a melt mixing process as compared to the unmodified polyester elastomers blended with biodegradable thermoplastic polyesters.

In certain embodiments, the invention encompasses compositions comprising and methods of making such modified elastomers. The modified elastomers, when blended with these biopolymers, exhibit improved mechanical properties compared to biodegradable thermoplastic polyester resins produced using unmodified elastomers. Moreover, the final compositions exhibited biodegradation and disintegration properties.

In various embodiments, the invention encompasses a production process of a compostable compatibilizing agent, the process of synthesis of the modified biodegradable elastomer, and melt blending of the modified elastomer and other biopolymers in specific weight ratios and order are provided.

In certain embodiments, the resin compositions can be remelted and reprocessed via melt processing techniques including, but not limited to, injection molding, compression molding, and cast film extrusion for different rigid and flexible polymeric applications.

In certain embodiments, the compostable compatibilizers extend the level of compatibility and the range of molecular weights of biodegradable thermoplastic polyesters. Likewise, the synthesis of modified biodegradable polyester elastomers increases various degrees of crosslinking, compatibility, or gel content of elastomer.

In certain embodiments, the resin development process extends the range of molecular weights of different polymers that can be used and melt-blended at various weight ratios.

Generally, the invention encompasses a composition comprising a biodegradable resin comprising in parts by mass (w/w) of about 10 to about 99.99 of at least one biodegradable polymers such as polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs), and combinations thereof. In various embodiments, the amount of the biodegradable thermoplastic polymer is about 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, 99.9%, or about 99.99%.

In one embodiment, the final resin composition includes a modified biodegradable elastomer of the current invention with a weight percent range of 1 to 90%. In various embodiments, the amount of the biodegradable elastomer is about 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, or about 90%.

In another embodiment, the compostable compatibilizing agent is the hydrolyzation reaction product of at least one biodegradable thermoplastic polyester, including, but not limited to, polylactic acid, polycaprolactone, polybutylene succinate, polybutylene succinate adipate, polybutylene succinate terephthalate, polybutylene adipate-co-terephthalate, polyhydroxyalkanoates, or a combination thereof.

In certain embodiments, the hydrolyzation reaction occurs in the presence of 0.01 to 30 weight percent of an organic acid, including, but not limited to, lactic acid, formic acid, stearic acid, tannic acid, malic acid, citric acid, aspartic acid, ascorbic acid, acetic acid and tartaric acid. In various embodiments, the amount of the organic acid is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

In another embodiment, the invention encompasses a method for the production of a hydrolyzed compatibilizer comprising a hydrolyzed compatibilizer produced by melt-compounding one or more biodegradable thermoplastic polyesters with one or more organic acids.

In certain embodiments, the hydrolyzed compatibilizer is produced by first melting one or more biodegradable thermoplastic polyesters and then compounding with one or more organic acids.

In another embodiment, the hydrolyzed compatibilizer is produced by melt-compounding one or more biodegradable thermoplastic polyesters with one or more organic acids and then further melt-compounding with one or more second biodegradable thermoplastic polyesters and one or more second organic acids.

In another embodiment, the hydrolyzed compatibilizer is produced by melt-compounding one or more biodegradable thermoplastic polyesters with one or more organic acids and then further compounding with one or more biodegradable thermoplastic polyesters.

In various embodiments, the aforementioned ingredients and methods of production of the hydrolyzed compatibilizer may be achieved using mixing and melt-compounding equipment with adjustable and controllable temperatures and shear rates, such as a twin screw extruder or a batch mixer. In a batch mixer, the processing temperature profile may range from about 50° C. to about 250° C., the mixing blade speed may be between about 20 and about 500 rpm and the processing time may be between a few seconds to several minutes.

Alternatively, in scenarios where single or twin screw extrusion is employed, the temperature profile may range from about 50° C. to about 250° C., and the screw speed may range from about 20 to about 500 rpm. It should be noted that the processing conditions and methods of production provided herein are not limiting and may vary based on other conditions such as ingredient ratios and the type of processing equipment.

In another embodiment, the hydrolyzed compatibilizing agent is a result of the hydrolyzation reaction of one or more biodegradable thermoplastic polyester with one or more organic acids at a temperature higher than ambient temperature.

In another embodiment, the hydrolyzed compatibilizing agent is a result of the hydrolyzation reaction of polylactic acid with one or more organic acids at a temperature higher than ambient temperature.

In another embodiment, the hydrolyzed compatibilizing agent is a result of the hydrolyzation reaction of polybutylene succinate with one or more organic acids at a temperature higher than ambient temperature.

In another embodiment, the hydrolyzed compatibilizing agent is a result of the hydrolyzation reaction of polybutylene adipate-co-terephthalate with one or more organic acids at a temperature higher than ambient temperature.

In another embodiment, the hydrolyzed compatibilizing agent is a result of the hydrolyzation reaction of polyhydroxyalkanoates with one or more organic acids at a temperature higher than ambient temperature.

In certain embodiments, the hydrolyzed compatibilizing agent is a result of the hydrolyzation reaction of polylactic acid and polybutylene succinate with one or more organic acids at a temperature higher than ambient temperature.

In certain embodiments, the hydrolyzed compatibilizing agent is a result of the hydrolyzation reaction of polylactic acid, polybutylene succinate, and polybutylene adipate-co-terephthalate with one or more organic acids at a temperature higher than ambient temperature.

In another embodiment, the unmodified biodegradable elastomer synthesis includes a polyol including, but not limited to, sorbitol, mannitol, galactitol, xylitol, ribitol, arabitol, erythritol, glycerol, threitol, and a derivative thereof and a saturated or unsaturated dicarboxylic acid including, but not limited to, succinic acid, sebacic acid, glutaric acid, hexanedioic acid, heptanoic acid, octanedioic acid, nonanedioic acid, and decanoic acid or a derivative thereof. In certain embodiments, the molar ratio of polyol to dicarboxylic acid is in the range of about 0.2 to about 1.5, preferably about 0.3 to about 1.4, and more preferably about 0.32 to about 1.28.

In another embodiment, the modified biodegradable elastomer synthesis includes a polyol including, but not limited to, sorbitol, mannitol, galactitol, xylitol, ribitol, arabitol, erythritol, glycerol, threitol and a derivative thereof and a saturated or unsaturated dicarboxylic acid including, but not limited to, succinic acid, sebacic acid, glutaric acid, hexanedioic acid, heptanoic acid, octanedioic acid, nonanedioic acid, and decanoic acid or a derivative thereof with a molar ratio range of about 0.2 to about 1.5, preferably about 0.3 to about 1.4, and more preferably about 0.32 to about 1.28 in the presence of 0.01 to 50 weight ratio of one or more hydrolyzed compostable compatibilizing agents. In various embodiments, the amount of the compatibilizer or compatibilizing agent is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, 40%, 42.5%, 45%, 47.5%, or about 50%.

In another embodiment, the modified biodegradable elastomer synthesis includes one or more polyols including, but not limited to, sorbitol, mannitol, galactitol, xylitol, ribitol, arabitol, erythritol, glycerol and threitol and saturated or unsaturated dicarboxylic acid including, but not limited to, adipic acid, azelaic acid, brassylic acid, dodecanedioic acid, glutaric acid, succinic acid, pimelic acid, suberic acid, sebacic acid, undecanedioic acid, tetradecanedioic acid, pentadecanedioic acid, oxalic acid, malonic acid, glutamic acid, aspartic acid, itaconic acid, glucaric acid, hexadecanedioic acid or a derivative thereof with a molar ratio range of about 0.2 to about 1.5, preferably about 0.3 to about 1.4, and more preferably about 0.32 to about 1.28 in the presence of 0.01 to 50 weight ratio of one or more biodegradable thermoplastic polyesters including, but not limited to, polylactic acid, polycaprolactone, polybutylene succinate, polybutylene succinate adipate, polybutylene succinate terephthalate, polybutylene adipate-co-terephthalate, polyhydroxyalkanoates and a combination thereof.

In certain embodiments, the biodegradable elastomer can be modified during the synthesis of the elastomer by the addition of a combination of different weight ratios of one or more compostable compatibilizing agents and neat biodegradable thermoplastic polyesters.

In certain embodiments, the method for the production of the modified biodegradable polyester elastomer comprises the use of at least a polyol, an organic acid, and a hydrolyzed compatibilizer or a neat polyester or a combination thereof as the reactants for this invention.

In certain embodiments, modified biodegradable polyester elastomer comprises a range of polyol and an organic acid in molar ratios of 0.32 to 1.28.

In certain embodiments, the reactants are mixed all together in a reaction vessel.

In another embodiment, the organic acid is melted prior to the addition of polyol and hydrolyzed compatibilizer or neat polyester (or a combination thereof) under stirring in a vessel. In another embodiment, the hydrolyzed compatibilizer or neat polyester (or a combination thereof) is mixed with the polyol prior to the addition of the organic acid. In another embodiment, the organic acid and polyol are mixed and heated to a desired temperature prior to the addition of the hydrolyzed compatibilizer or neat polyester (or a combination thereof) at different times during the synthesis. In another scenario, the organic acid and polyol are mixed and heated to a desired temperature prior to the addition of the hydrolyzed compatibilizer or neat polyester (or a combination thereof) at different times during the synthesis, wherein the hydrolyzed compatibilizer or neat polyester have previously been heated to a desired temperature. The reaction vessel could be made of heat and crack-resistant glassware, stainless steel, or high-temperature-resistant plastic equipped with an overhead stirrer. The temperature of the mixtures is increased to the desired reaction temperature and maintained throughout the reaction. The reaction is either cooled slowly or rapidly and considered complete after a time period ranging from a few minutes to a few hours.

In certain embodiments, the reaction is set at temperatures ranging from about 100 to about 250° C. In certain embodiments, reagents are agitated from the point of mixture and at room temperature. In another embodiment, the agitation is started after the reagents are in a molten state. In certain embodiments, the reaction continues until the desired consistency of the elastomer is achieved.

In one embodiment, agitation continues after achieving the desired consistency of elastomer for a time period ranging from 1 minute to a few hours.

In another embodiment, the agitation is increased after achieving the desired consistency of elastomer. In another embodiment, agitation is stopped after achieving the desired consistency of elastomer.

In certain embodiments, the composition is a combination of any of the following polymers and/or elastomers: polylactic acid, polycaprolactone, polybutylene succinate, polybutylene succinate adipate, polybutylene succinate terephthalate, polybutylene adipate-co-terephthalate, polyhydroxyalkanoates, modified elastomer of the current invention or unmodified elastomer.

In one embodiment, the composition is a mixture of polylactic acid and modified biodegradable elastomer, where the biodegradable elastomer is modified and synthesized in the presence of either polylactic acid, hydrolyzed polylactic acid, or a combination thereof.

In another embodiment, the composition is a mixture of polyhydroxyalkanoates and modified biodegradable elastomer, where the biodegradable elastomer is modified and synthesized in the presence of either polyhydroxyalkanoates, hydrolyzed polyhydroxyalkanoates, or a combination of them.

In another embodiment, the composition is a mixture of polybutylene succinate and a modified biodegradable elastomer, where the biodegradable elastomer is modified and synthesized in the presence of either polybutylene succinate, hydrolyzed polybutylene succinate, or a combination thereof.

In another embodiment, the composition is a mixture of polybutylene adipate-co-terephthalate and modified biodegradable elastomer, where the biodegradable elastomer is modified and synthesized in the presence of either polybutylene adipate-co-terephthalate, hydrolyzed polybutylene adipate-co-terephthalate, or a combination thereof.

In certain embodiments, the plasticization of a resin comprising biodegradable thermoplastic polyester(s) and modified elastomer is achieved at different weight percentages, including, but not limited to, 0 to 30 of a biodegradable plasticizer.

In certain embodiments, biodegradable plasticizers are employed, which include, but are not limited to, one or more plant-based oils obtained from sources such as vegetables, nuts, grains, seeds, etc. Examples of such oils include, but are not limited to, corn oil, soybean oil, and glycerol. These plant-based oils can be used either in their virgin form or after modification (e.g., through epoxidation, carboxylation, hydroxylation, or amidation). Modified plant-based oils such as epoxidized soybean oil, epoxidized linseed oil, fatty acid methyl esters, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g., xylitol, sorbitol, lactitol, mannitol, erythritol, or maltitol), isosorbide diester, and fatty acid methyl esters (FAME), are also encompassed.

In certain embodiments, the resin further includes filler(s) in weight percentages, ranging from about 0 to about 30 which encompasses both inorganic and biomass fillers and a combination thereof. In various embodiments, the amount of the inorganic and/or biomass fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, or about 30%.

In certain embodiments, the inorganic fillers include, but are not limited to, wollastonite, mica, clay, calcium carbonate, glass fiber, talc, aluminum silicate, zirconium oxide, sepiolite, gypsum and other minerals and a combination thereof.

In certain embodiments, the biomass includes, but is not limited to, distillers' grains, vinasse, vinegar residues, wood fiber, virgin starch, modified starch including thermoplastic starch, agricultural cellulosic matter from including, but not limited to, straw, stalk, shive, hurd, bast, leaf, seed, fruit, and perennial grass, all in a non-continuous non-woven form including chopped pieces, particulates, dust or flour.

In certain embodiments, the compositions exhibit an improvement in elongation at break of 120% after the compatibility between the elastomer, and the biodegradable thermoplastic polyester is improved.

In certain embodiments, the compositions exhibit an increase in rigidity (represented by tensile modulus) of about 20 to about 30%, preferably about 26% after the compatibility between the elastomer and the biodegradable thermoplastic polyester is improved.

In certain embodiments, the compositions exhibit an increase in strength (represented by tensile stress at break) of about 10 to about 20%, preferably about 17% after the compatibility between the elastomer and the biodegradable thermoplastic polyester is improved.

In certain embodiments, the melt flow index (MFI) decreases by more than 65% after the compatibility between the elastomer and the biodegradable thermoplastic polyester is improved.

In certain embodiments, the composition exhibits a bio-based carbon content of up to 100%.

In certain embodiments, the composition exhibits a disintegration of more than about 25%, preferably more than about 30%, more preferably more than about 37% within 2 months of being in soil at ambient (25° C.) temperature.

In certain embodiments, the compositions exhibit a bio-based carbon content of up to 100%. In certain embodiments, the composition exhibits a bio-based carbon content of about 10%, 20%, 30%, 40%, 50%, 60%, 70%, 80%, 90%, 95%, or about 99%.

In certain embodiments, the composition exhibits 10%, 20%, 30%, 40%, 50%. 60%, 70%, 80%, or 90% disintegration completion within about 180 to about 365 days at ambient temperature.

In certain embodiments, the composition exhibits 10%, 20%, 30%, 40%, 50%. 60%, 70%, 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the composition exhibits a disintegration onset of about 7 days on average, in soil at ambient temperature.

In certain embodiments, the composition exhibits about 50%, preferably about 60%, more preferably about, 70% and even more preferably about 79% biodegradation within 45 days in thermophilic (about 55° C.-60° C.) temperatures.

In certain embodiments, the composition is 100% compostable.

In certain embodiments, the composition is compostable within 90 days in real-world aerobic composting conditions.

In certain embodiments, the biopolymer(s) are first melt-compounded by means of a batch mixer or extruder for a prescribed time period at temperatures higher than ambient temperature and then the modified biodegradable elastomer is introduced to the molten biopolymer(s).

In certain embodiments, the biopolymer(s) and modified biodegradable elastomer are melt-compounded by means of a batch mixer or extruder for a prescribed time period at temperatures higher than ambient temperature simultaneously.

In certain embodiments, the other additives may be introduced into the compounding zone at any point during the process.

The additives can include, but are not limited to, biodegradable plasticizers, biomasses, inorganic or organic fillers, processing aids, coupling agents, compatibilizers, chain extenders, pigments, initiators, and peroxides.

In certain embodiments, the method includes further remelting and forming flexible or rigid polymeric parts via conventional polymer processing techniques including, but not limited to, compression molding, hot press, blow molding, cast film extrusion, injection molding, and thermoforming.

In one embodiment, the invention encompasses forming polymeric parts using the resin formulation includes extrusion, where the extrudate is formed at a temperature above ambient temperature, preferably in a range of 120 to 250° C.

In certain embodiments, the biodegradable compositions of the invention can be used in various embodiments from single-use products to durable products and in a wide range of applications, such as packaging, medical, consumer products and many more.

### DETAILED DESCRIPTION OF THE INVENTION

### Definitions

As used herein, the term “additive” could refer to any material used to enhance a targeted property or function of material and/or composition, which could be in any form such as solid, liquid, powder, fiber, or crystal.

The term “blend” and “resin” as used herein, refers to a homogeneous mixture of two or more different polymers and/or elastomers along with other additives.

The term “bio-based” or “biobased” refers to compositions that are derived from plant-based materials instead of being derived from petroleum.

The prefix “bio” as used herein refers to a material that has been derived from a renewable biological resource.

The term “biodegradable” refers to compositions of the invention that can biodegrade within 12 months in a compost environment in a non-toxic, environmentally compatible manner with no heavy metal or PTFE contents, while remaining soil-safe (i.e., lack of eco-toxins). The compositions of the invention biodegrade within 12 months. Plastic that is compostable is biodegradable, but not every plastic that is biodegradable is compostable. The compositions of the invention are both biodegradable and compostable. As used herein, “biodegradable” compositions are engineered to biodegrade in compost, soil, or water. In particular, biodegradable plastics are plastics with innovative molecular structures that can be decomposed by bacteria at the end of their life under certain environmental conditions.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce these renewable feedstocks for plastic production include, but are not limited to, corn starch, corn stalks, sugarcane stems, cellulose, and various oils and fats from renewable sources.

As used herein, “compostable” compositions refer to biodegradation into soil conditioning material (i.e., compost). In order for a plastic to be labeled as industrial “compostable”, it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standard D6400 outlines the specifications that must be met in order to label a plastic as industrial “compostable”.

The term “compatibilizing agent” or “compatibilizer” refers to biodegradable thermoplastic polyesters or hydrolyzed biodegradable thermoplastic polyesters that are being used in the synthesis process of modified polyester elastomers to improve the compatibility of the elastomers with the biodegradable thermoplastic polyesters.

The term “hydrolyzation” refers to the simultaneous reduction and functionalization of biodegradable thermoplastic polyester chains, resulting in the formation of either oligomers or polymers of a lower molecular weight with functional groups like, but not limited to hydroxyls, carboxyls, carbonyls, anhydrides, epoxides, and esters.

The term “disintegration” refers to a plastic product that leaves no more than 10% of its original dry weight after twelve weeks (84 days) in a controlled thermophilic composting test and sieved through a 2.0-mm sieve.

The term “modified biodegradable elastomer” or “modified biodegradable polyester elastomer” is used herein to define a pristine biodegradable elastomer that has undergone modifications during its synthesis to improve its compatibility with biodegradable thermoplastic polyesters. These modifications might encompass the incorporation of additives such as hydrolyzed biodegradable thermoplastic polyesters or biodegradable thermoplastic polyesters as one of the synthesis reagents of the biodegradable elastomer.

The term “polyhydroxyalkanoates (PHAs)” refers to a family of bio-based thermoplastic polyesters synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

The term “polyesters” refers to polymers of the invention that are obtained, for example, from aliphatic diols, aliphatic dicarboxylic acids, and aromatic dicarboxylic acids/esters. The term polyesters also includes aliphatic and aliphatic-aromatic polyesters. The “biodegradable thermoplastic polyesters” of the current invention include but are not limited to polylactic acid (PLA) or poly(lactic acid) (PLA); polycaprolactone (PCL); poly(butylene succinate) (PBS) or polybutylene succinate (PBS); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); polyhydroxyalkanoates (PHAs), and combinations thereof.

The term “thermoplastic”, as used herein, refers to a material, such as a polymer, which softens when heated and becomes moldable and pliable, then hardens when cooled.

The term “unmodified biodegradable elastomer” or “unmodified biodegradable polyester elastomer” are herein defined to refer to an elastomer synthesized from its fundamental reactants, devoid of supplementary additives.

The term “wt. %”, “parts by mass (w/w)” or “parts by mass % (w/w)”, as used herein, refer to the percentage weight of an ingredient of a composition with respect to the total weight of the composition.

The invention generally encompasses compositions of modified biodegradable polyester elastomer and the biodegradable polymer resins made thereof, methods of synthesis and manufacturing, and methods of using the biodegradable resin compositions including, but not limited to (i) about 10-99% (w/w) of a polymer comprising one or more of biodegradable thermoplastic polyesters; and (ii) about 1-90% (w/w) modified biodegradable elastomer of the current invention, wherein the biodegradable resin composition exhibits improved mechanical properties as a result of enhanced compatibility between the modified biodegradable elastomer and biodegradable thermoplastic polyester(s) compared to the counterpart compositions comprising of unmodified biodegradable elastomer.

In certain embodiments, the biodegradable compositions could further include one or more additives selected from the group consisting of one or more of (i) a plasticizer in an amount ranging from about 0 to about 30% (w/w); (ii) an inorganic filler in an amount ranging from about 0 to about 30% (w/w); (iii) a biomass in an amount ranging from about 0 to about 30% (w/w); (iv) additional additives such as coupling agent(s), compatibilizer(s) including the hydrolyzed compostable compatibilizing agents of the current invention, pigments, initiator(s), peroxide(s), chain extender(s), and a cross-linker in an amount ranging from 0 to 10% (w/w), or combinations thereof.

In certain embodiments, the compositions exhibit a bio-based carbon content of 100%.

In certain embodiments, the compositions exhibit improvement in elongation at break of about 120% for the compatibilized resin blend.

In certain embodiments, the compositions exhibit increases in tensile modulus by about 26% for the compatibilized resin blends.

In certain embodiments, the compositions exhibit improvement in tensile strength at break by about 17% for the compatibilized resin blends.

In certain embodiments, the melt flow index (MFI) decreased by more than 65% for the compatibilized resin blends.

In certain embodiments, the composition exhibits a 79% biodegradation within 45 days in thermophilic conditions.

In certain embodiments, the composition exhibits a disintegration onset within 7 days, on average, in soil at ambient temperature.

In certain embodiments, the compositions include one or more polymers. In these embodiments, one or more of these polymers are biodegradable thermoplastic polyesters including, but not limited to, polylactic acid, polycaprolactone, polybutylene succinate, polybutylene succinate adipate, bio-elastomers, polybutylene succinate terephthalate, polybutylene adipate terephthalate, or polyhydroxyalkanoates.

Without being limited by theory, the inventors have discovered that the distinctive characteristics of biodegradable thermoplastic polyesters such as polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs), lie in the inherent biodegradability, compostability and in some cases, the high bio-based carbon content. Preserving these fundamental attributes becomes important when aiming at improving the mechanical or thermal properties of these materials. While seeking to increase compatibility between these polyesters and bio-based polyester elastomers such as polyglycerol azelate (PGAz), polyglycerol sebacate (PGS), polyglycerol adipate (PGAd), polyglycerol succinate (PGSu), polyglycerol malonate (PGMa), polysorbate, poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd) and poly(maltitol-co-suberate) (PMaS), existing technologies often compromise on the biodegradability, compostability or the bio-based carbon content of the resultant blend.

In certain embodiments, the compositions include modified biodegradable polyester elastomers.

In certain embodiments, the modified biodegradable elastomer is inclusive of, but not limited to, modified polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz), poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd) and poly(maltitol-co-suberate) (PMaS).

In certain embodiments, the hydrolyzed compatibilizing agent is inclusive of, but is not limited to, hydrolyzed polylactic acid, hydrolyzed polycaprolactone, hydrolyzed polybutylene succinate, hydrolyzed polybutylene succinate adipate, hydrolyzed polybutylene succinate terephthalate, hydrolyzed polybutylene adipate terephthalate, or hydrolyzed polyhydroxyalkanoates, where the hydrolyzation is achieved by melt-compounding under a specified time and temperature.

In certain embodiments, the composition includes biomass, inorganic filler, coupling agent, and plasticizer.

In certain embodiments, the biomass is inclusive of, but is not limited to, distillers' grains, vinasse, vinegar residues, wood fiber, virgin starch, modified starch including thermoplastic starch, agricultural cellulosic matter from including, but not limited to, straw, stalk, shive, hurd, bast, leaf, seed, fruit, and perennial grass, all in a non-continuous non-woven form including chopped pieces, particulates, dust or flour.

In certain embodiments, the inorganic filler includes but is not limited to, wollastonite, mica, clay, calcium carbonate, glass fiber, talc, aluminum silicate, zirconium oxide, gypsum and other minerals and a combination thereof.

In certain embodiments, the plasticizers encompass, but are not limited to, one or more plant-based oils obtained from sources such as vegetables, nuts, grains, seeds, etc. Examples of such oils include, but are not limited to, corn oil, soybean oil, and glycerol. These plant-based oils can be used either in their virgin form or after modification (e.g., through epoxidation, carboxylation, hydroxylation, and amidation). Modified plant-based oils such as epoxidized soybean oil, epoxidized linseed oil, fatty acid methyl esters, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In certain embodiments, the coupling agent or compatibilizer includes, but is not limited to, the hydrolyzed compatibilizer of this invention, titanate, aluminate, peroxides, y-aminopropyltriethoxysilane, Y-(2,3) epoxy (propoxy) propyltrimethoxy-silane, y-methacryloxypropyltrimethoxysilane, lactic acid, formic acid, stearic acid, tannic acid, malic acid, citric acid, aspartic acid, ascorbic acid, acetic acid, tartaric acid.

In other embodiments, the invention includes methods for preparing the biodegradable composition comprising the following steps; synthesizing modified elastomer as a product of the reaction between at least one organic dicarboxylic acid and one polyol in the presence of a hydrolyzed biodegradable thermoplastic polyester(s) and then melt-blending with one or more biodegradable thermoplastic polyesters and other additives of the biodegradable composition at temperatures higher than ambient temperature to prepare the biodegradable resin composition.

In other embodiments, the invention includes methods for preparing the biodegradable composition comprising the following steps; synthesizing modified elastomer as a product of the reaction between at least one organic dicarboxylic acid and one polyol in the presence of biodegradable thermoplastic polyester(s) and then melt-blending with one or more biodegradable thermoplastic polyesters and other additives of the biodegradable composition at higher than ambient temperatures to prepare the biodegradable resin composition.

In other embodiments, the invention includes methods for preparing the biodegradable composition comprising the following steps; synthesizing modified elastomer as a product of the reaction between at least one organic dicarboxylic acid and one polyol in the presence of biodegradable thermoplastic polyester(s) and hydrolyzed biodegradable thermoplastic polyester(s), and then melt-blended with one or more biodegradable thermoplastic polyesters and other additives of the biodegradable composition at higher than ambient temperatures to prepare the biodegradable resin composition.

In other embodiments, the invention includes methods for preparing the compostable hydrolyzed compatibilizer.

In one embodiment, the hydrolyzed compatibilizer is produced by melt-compounding one or more biodegradable thermoplastic polyesters with one or more organic acids.

In one embodiment, the hydrolyzed compatibilizer is produced by first melting one or more biodegradable thermoplastic polyesters and then compounding with one or more organic acids.

In one embodiment, the hydrolyzed compatibilizer is produced by melt-compounding one or more biodegradable thermoplastic polyesters with one or more organic acids and then further melt-compounding with one or more biodegradable thermoplastic polyesters and organic acids.

In one embodiment, the hydrolyzed compatibilizer is produced by melt-compounding one or more biodegradable thermoplastic polyesters with one or more organic acids and then further compounding with one or more biodegradable thermoplastic polyesters.

The aforementioned ingredients and methods of production may be achieved using mixing and melt-compounding equipment with adjustable and controllable temperatures, such as a single or twin screw extruder, or a batch mixer. In a batch mixer, the processing temperature profile may range from 50 to 250° C., the mixing blades' speed may be between 20 and 500 rpm and the processing time may be between a few seconds to several minutes. Alternatively, in scenarios where single or twin screw extrusion is employed, the temperature profile may range from 50 to 250° C., and the screw speed may range from 20 to 250 rpm. It should be noted that the processing conditions and methods of production provided herein are not limiting and may vary based on other conditions such as ingredient ratios and the type of processing equipment.

The order of mixing the raw ingredients is not limited only to the above-mentioned methods and may include any other possible combinations.

In certain embodiments, the methods further comprise forming the resin into articles using conventional polymer processing techniques such as thermoforming, hot press, vacuum forming, cast extrusion, film blowing, injection molding, or compression molding.

In embodiments, the invention encompasses a hydrolyzed compostable compatibilizer comprising: about 70 to about 99.99% (w/w) of at least one biodegradable thermoplastic polyester selected from the group consisting of polylactic acid, polycaprolactone, polybutylene succinate, polybutylene succinate adipate, polybutylene succinate terephthalate, polybutylene adipate-co-terephthalate, polyhydroxyalkanoates and a combination thereof; and about 0.01 to about 30% (w/w) of an organic acid selected from the group consisting of lactic acid, formic acid, stearic acid, tannic acid, malic acid, citric acid, aspartic acid, ascorbic acid, acetic acid, tartaric acid or a combination thereof.

In certain embodiments, the invention encompasses a modified biodegradable polyester elastomer comprising at least one polyol selected from the group consisting of sorbitol, mannitol, galactitol, xylitol, ribitol, arabitol, erythritol, glycerol, threitol and derivatives thereof, and at least one saturated or unsaturated organic acid selected from the group consisting of succinic acid, sebacic acid, glutaric acid, hexanedioic acid, heptanoic acid, octanedioic acid, nonanedioic acid, and decanoic acid or derivatives thereof, with a molar ratio of polyol and organic acid about 0.3 to about 1.3 and further comprising about 0.01 to about 50 weight ratio of one or more compostable compatibilizing agents, wherein the compostable compatibilizing agent comprises at least one biodegradable thermoplastic polyester selected from polylactic acid, polycaprolactone, polybutylene succinate, polybutylene succinate adipate, polybutylene e succinate terephthalate, polybutylene adipate-co-terephthalate, polyhydroxyalkanoates and a combination thereof; or at least one hydrolyzed compostable compatibilizer.

In certain embodiments, the molar ratio of polyol and organic acid is about 0.32 to about 1.28.

In certain embodiments, the invention encompasses a biodegradable resin composition comprising:
about 10 to about 99% (w/w) of a polymer comprising one or more of biodegradable thermoplastic polyesters;
about 1 to about 90% (w/w) of modified biodegradable polyester elastomers;
about 0 to about 30% (w/w) of one or more plasticizers;
about 0 to about 30% (w/w) of one or more of inorganic fillers;
about 0 to about 30% of fiber comprising one or more of biomass.
about 0 to about 10% (w/w) of coupling agents, compatibilizers, chain extenders, peroxides, processing aids, initiators, pigments, and cross-linkers or a combination thereof.

In certain embodiments, the invention encompasses a biodegradable resin composition comprising:
about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or to about 99% (w/w) of a polymer comprising one or more of biodegradable thermoplastic polyesters;
about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, to about 90% (w/w) of modified biodegradable polyester elastomers;
about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, to about 30% (w/w) of one or more plasticizers; about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, to about 30% (w/w) of one or more of inorganic fillers;
about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, to about 30% of fiber comprising one or more of biomass; and
about 0, 1, 2, 3, 4, 5, 6, 7, 8, 9, to about 10% (w/w) of coupling agents, compatibilizers, processing aids, chain extenders, peroxides, initiators, pigments, and cross-linkers or a combination thereof.

In certain embodiments, the biodegradable thermoplastic polyesters is polylactic acid, polycaprolactone, polybutylene succinate, polybutylene succinate adipate, polybutylene succinate terephthalate, polybutylene adipate-co-terephthalate, polyhydroxyalkanoates and a combination thereof.

In certain embodiments, the plasticizers are plant-based oils including, but not limited to, corn oil, soybean oil, and glycerol.

In certain embodiments, one or more plant-based oils can be used either in their virgin form or after modification (e.g., through epoxidation, carboxylation, hydroxylation, or amidation). Modified plant-based oils such as epoxidized soybean oil, epoxidized linseed oil, fatty acid methyl esters, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME), are also encompassed.

In certain embodiments, the inorganic fillers are selected from wollastonite, mica, clay, calcium carbonate, glass fiber, talc, aluminum silicate, zirconium oxide, sepiolite, gypsum and other minerals and a combination thereof.

In certain embodiments, the biomass is distillers' grains, vinasse, vinegar residues, wood fiber, virgin starch, modified starch (including thermoplastic starch), agricultural cellulosic matter from including, but not limited to, straw, stalk, shive, hurd, bast, leaf, seed, fruit, and perennial grass all in a non-continuous non-woven form, which may consist of chopped pieces, particulates, dust, or flour or a combination thereof.

In certain embodiments, the compatibilizer is a hydrolyzed compostable compatibilizing agent.

In certain embodiments, the invention includes a resin of a modified biodegradable polyester elastomer and at least one biodegradable thermoplastic polyester, wherein the composition exhibits enhanced compatibility as evidenced by improved mechanical properties, as compared to a similar composition made with unmodified biodegradable elastomers.

In certain embodiments, the bio-based carbon content of the composition is up to 100%.

In certain embodiments, the composition exhibits more than 75, 76, 77, 78, 79, 80, 81, 82, 83, 84, 85, 86, 87, 88, 89, 90, 91, 92, 93, 94, 95, 96, 97, 98, or about 99% biodegradation in less than 45 days and more than 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or to about 99% disintegration in less than 10 days, and under thermophilic temperature conditions.

The invention further encompasses a method of producing the modified biodegradable polyester elastomer in which the ingredients react at a temperature between about 100 to about 250° C. and continue the reaction until the desired texture of the modified elastomer is achieved.

In certain embodiments, the method of producing the hydrolyzed compostable compatibilizing agent comprise one or more biodegradable thermoplastic polyesters and one or more organic acids mixed and melt-compounded together in a polymer processing equipment or apparatus comprising batch mixer, a twin or single screw extruder, and at elevated temperatures for a time period of several seconds to several minutes of from about 2 to about 20 min.

In certain embodiments, the method of producing the biodegradable resin composition comprises ingredients are mixed and melt-compounded together in a polymer processing equipment or apparatus comprising a batch mixer, a or single screw extruder, at elevated temperatures for a time period of several seconds to several minutes, of from about 2 to about 10 min.

In certain embodiments, the bio-based carbon content of the compatibilizer is up to 100%.

In certain embodiments, the bio-based carbon content of the elastomer is up to 100%.

In certain embodiments, using conventional polymer processing techniques comprising cast film extrusion and injection molding techniques.

### The Compositions of this Invention

### Hydrolyzed Compostable Compatibilizer Synthesis

Hydrolyzed compostable compatibilizer production mainly consists of melt-compounding one or more compostable thermoplastic polyesters including but not limited to polylactic acid, polycaprolactone, polybutylene succinate, polybutylene succinate adipate, polybutylene succinate terephthalate, polybutylene adipate-co-terephthalate, and polyhydroxyalkanoates in the presence of one or more organic acids including but not limited to lactic acid, formic acid, stearic acid, tannic acid, malic acid, citric acid, aspartic acid, ascorbic acid, acetic acid, tartaric acid. Typically, but not limiting, the thermoplastic polyester(s) is melt-compounded in the presence of 0.01 to 30 weight percent of organic acid(s) using a batch mixer or a recirculating twin screw extruder such as a micro-compounder at elevated temperatures, which can be from 50 to 300° C., at a certain mixing screw or mixing blade speed, for example, 20 rpm and above, for a specified time which could be from a few seconds to several minutes. Alternatively, the polyester(s) and organic acid(s) can be melt-compounded using continuous polymer processing methods such as single or twin screw extrusion at elevated temperatures ranging from 50 to 300° C., at a certain mixing screw speed, for example, 20 rpm and above, for a specified time which could be from a few seconds to several minutes. Once the desired processing conditions and molecular weight are met, the melt is extruded, cooled, and the strands pelletized and stored away for further use.

### Modified Biodegradable Polyester Elastomer Synthesis

Unmodified biodegradable polyester elastomer production mainly consists of the use of a polyol such as pure sorbitol, mannitol, galactitol, xylitol, ribitol, arabitol, erythritol, glycerol, threitol or a derivative thereof and an organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof as the reactants for this invention. The polyols and organic acids can be sourced from fully bio-based, partially bio-based, non-bio-based sources, or a combination thereof

These unmodified biodegradable polyester elastomers include, but are not limited to, polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd), and poly(maltitol-co-suberate) (PMaS).

In one scenario, synthesis of the modified elastomer employs a range of polyol: organic acid molar ratios of 0.32 to 1.28 in the presence of 0.01 to 50 wt. % of at least one biodegradable thermoplastic polyester or hydrolyzed compostable compatibilizer of the invention or a combination thereof.

In another scenario, the modified biodegradable polyester elastomer is synthesized from a polyol and an organic acid in the presence of other organic chemicals as additives to render additional functionality onto the chemical structure of the resulting polyester elastomer.

In one scenario, for synthesizing modified biodegradable elastomers, the organic acid is in a molten state prior to introducing a polyol, along with one or more biodegradable thermoplastic polyesters or one or more hydrolyzed compatibilizers, or a combination thereof, alongside other additives into a vessel under stirring. In another scenario, the organic acid and polyol are in a molten state and mixed together for a time period prior to introducing one or more biodegradable thermoplastic polyesters or one or more hydrolyzed compatibilizers, or a combination thereof, alongside other additives. In another scenario, the hydrolyzed compatibilizer or neat polyester, or a combination thereof is mixed with the polyol prior to the addition of the organic acid and other additives.

The reaction vessel could be made of heat and crack-resistant glassware, stainless steel, or high-temperature-resistant plastic equipped with an overhead stirrer. The temperature of the mixture is increased to the desired reaction temperature and maintained throughout the reaction. The reaction can either be cooled rapidly or slowly to ambient temperature and considered complete after a time period that could range from a few minutes to a few hours.

The reaction is set at elevated temperatures ranging from 100 to 250° C. Reagents are agitated from the point of mixture and at room temperature. In another scenario, the agitation is started after the reagents are melted. The reaction continues until the desired consistency of the elastomer is achieved. In one scenario, agitation continues after achieving the desired consistency of elastomer for a time period ranging from a few minutes to a few hours. In another scenario, the agitation is increased after achieving the desired consistency of elastomer. In another scenario, agitation is stopped after achieving the desired consistency of elastomer.

The biodegradable thermoplastic polyester or biodegradable hydrolyzed compatibilizer selected for use in the synthesis of the biodegradable polyester elastomer depends on the resin that will be produced with the modified elastomer in the later polymer blending production.

However, it is not limited to the specific biodegradable thermoplastic polyester(s) with which the modified elastomer will be blended. Any combination of hydrolyzed biodegradable thermoplastic polyesters, used as compatibilizing agents, can be used to modify the elastomers for blending with any combination of biodegradable thermoplastic polyesters for resin production.

### Biodegradable Polymer Resin Composition

The present invention encompasses methods for improving the compatibility between biodegradable thermoplastic polyesters and biodegradable polyester elastomers by modification of biodegradable polyester elastomers, and the melt-blending process of the resultant modified elastomer with the biodegradable thermoplastic polyesters.

The resin composition comprises one or more of biodegradable thermoplastic polyester polymers, within a concentration ranging from 10-99 wt. % and a modified biodegradable polyester elastomer within a concentration ranging from 1-90 wt. %.

Additionally, the resin can include plasticizers within a concentration ranging from 0-30 wt. %, inorganic and organic fillers within a concentration ranging from 0-30 wt. %, and/or fibers in a concentration ranging from 0-30 wt. %. Furthermore, additional additives such as coupling agents and compatibilizers including, but not limited to, the hydrolyzed compostable compatibilizing agents of the current invention, chain extenders, peroxides, initiators, pigments, and cross-linkers may be included with a concentration ranging from 0-10 wt. %.

### Biodegradable Polymer Resin Production

The aforementioned ingredients may be processed together in various scenarios. In one scenario, all ingredients are premixed and melt-processed together. In another scenario, the biodegradable thermoplastic polyester(s) is melted first, and then the modified biodegradable elastomer is added to the system along with other additives and fillers.

In yet another scenario, the modified biodegradable elastomer is first charged into the processing equipment, and then the biodegradable thermoplastic polyester(s) is added thereafter along with other additives and fillers. In another scenario, the biodegradable thermoplastic polyester(s) is melted first, and then the biodegradable compatibilizer(s) is introduced to the molten biodegradable thermoplastic polyester(s) and allowed to melt-blend, and then the modified biodegradable elastomer is added afterward along with other additives and fillers. In yet another scenario, the biodegradable thermoplastic polyester(s) is melted first, and then the modified biodegradable elastomer is added to the molten biodegradable thermoplastic polyester(s), allowed to melt-blend, and the biodegradable compatibilizer(s) along with other additives and fillers are added thereafter. The order of introducing the ingredients to the system is not limited to these scenarios and may include any other possible scenarios and combinations.

The blending of the aforementioned ingredients may be achieved using mixing and melt-compounding equipment with adjustable and controllable temperatures, such as a single or twin screw extruder, or a batch mixer. In a batch mixer, the processing temperature profile may range from 50 to 250° C. and the processing time may be between 5 to 60 minutes. Alternatively, in scenarios where single or twin screw extrusion is employed, the temperature profile may range from 50 to 250° C., and the screw speed may range from 20 to 250 rpm. It should be noted that the processing conditions provided herein are not limiting and may vary based on other conditions such as ingredient ratios and the type of processing equipment. The resulting product may be pelletized and subsequently formed into desired shapes and parts using conventional forming techniques including, but limited to, injection molding, thermoforming, or extrusion into films or sheets. The forming temperature is typically within the range used in the melt-processing and compounding of the resins and ingredients.

### EXAMPLES

Example 1: Hydrolyzed compatibilizer is produced using a kneader by melt-compounding 2000 grams polylactic acid (PLA) for 5 minutes at 190° C. and then adding 20 grams (i.e. 1 phr or part per hundred resin) of an organic acid. The mixture is allowed to melt-blend for 10 min at 190° C. At this point, the melt is cooled to temperatures of around 100 to 120° C. and extracted. The sample is collected, crushed using a crusher, bagged and stored away for further use.

Example 2: Synthesis of modified biodegradable polyester elastomer using a biodegradable thermoplastic polyester as a compatibilizing agent and then making the blend with modified elastomer and biodegradable thermoplastic polyester using a kneader for injection applications.

Initially, 518 grams of pure glycerol and 832 grams of succinic acid, with a molar ratio of 0.8, were mixed within a 3-liter atmospheric pressure reactor at ambient temperature.

To this mixture, 10 wt. % polylactic acid (PLA) was added with respect to the total weight of glycerol and succinic acid. The synthesis reaction was initiated by increasing the temperature using a conventional heater connected to the vessel and equipped with a temperature controller, and stirred vigorously with two overhead stirrers. The reaction temperature was set to 180° C. and proceeded for approximately 3 hours until a gelatinized elastomer was formed. Subsequently, the modified elastomer was allowed to cool to room temperature before further processing.

For the resin blend, 80 wt. % of neat PLA was loaded into a preheated kneader operating at 190° C. and 35 rpm and allowed to melt. To this, 20 wt. % of the modified biodegradable elastomer was added once the PLA was in its molten state and allowed to blend for a duration of 10 minutes under the presence of shear and heat. The resulting material was extracted from the kneader, cooled to room temperature and crushed into small particles using a mechanical crusher. The crushed material is subsequently fed into an injection molding machine with a temperature profile of 160 to 180° C., a screw speed of 75 rpm and a mold at room temperature.

The purpose of injection molding was to evaluate the mechanical properties in accordance with ASTM test standards. The results were compared with a blend comprised of 80 wt. % PLA and 20 wt. % unmodified elastomer made under similar processing conditions. As a result of improved compatibility, a 32% improvement in elongation at break from 7.5 to 9.9% and a 26% improvement in Young's modulus from 2285 to 2874 MPa were observed. Furthermore, the maximum flexural strength increased by 19% from 45.2 to 53.6 MPa and Izod impact energy improved by 14.6% from 22.9 to 26.2 J/m, while the melt flow index (MFI) decreased by 28% from 63 to 45.5 g/10 min.

Example 3: Synthesis of modified biodegradable elastomer with a hydrolyzed biodegradable thermoplastic polyester made as described under Example 1, as a compatibilizing agent and then making the blend with modified elastomer and biodegradable thermoplastic polyester using a kneader for film applications.

Initially, 461 grams of pure glycerol and 739 grams of succinic acid, with a molar ratio of 0.8 were mixed in a 3-liter atmospheric reactor at ambient temperature.

To this mixture, 20 wt. % hydrolyzed polylactic acid (HPLA) (made as described under embodiment 1) was added with respect to the total weight of glycerol and succinic acid. The synthesis reaction was initiated by increasing the temperature through a conventional heater connected to the vessel and equipped with a temperature controller, and stirred vigorously with two overhead stirrers. The reaction temperature was set and maintained at 180° C. and proceeded for approximately 3 hours until a gelatinized elastomer was formed. Subsequently, the modified elastomer was allowed to cool to room temperature before further processing.

For the resin blend, 80 wt. % of neat PLA was loaded into a preheated kneader operating at 190° C. and 35 rpm and allowed to fully melt. 20 wt. % of the modified biodegradable elastomer was added to molten PLA and blended for an additional 10 minutes under shear and heat. Then the resulting material was extracted from the kneader, cooled to room temperature, and crushed into small particles using a mechanical crusher. The crushed material was then extruded into a film roll with a thickness of 0.32 mm and a width of 10-12 inches, using a cast film extruder at a temperature profile of 140 to 170° C. and a screw speed of 50 rpm. The film was chilled and pulled via a set of chiller rollers and guiding and winding rollers to form a wound spool of the film. The mechanical properties were then evaluated using ASTM methods.

The results were compared to similar resin blends made with unmodified elastomer under similar processing conditions. As a result of the enhanced compatibility, remarkable improvements in stress at break by 13% from 27 to 30.6 MPa and 17% from 23.4 to 27.4 MPa were observed for machine and transverse directions, respectively. Stress at yield improved by 7% from 31.5 to 33.6 MPa and 15% from 25.4 to 29.1 MPa for machine and transverse directions, respectively. Young's modulus improved by 7% from 1769 to 1890 MPa and 14% from 1621 to 1854 MPa for machine and transverse directions, respectively. Additionally, the elongation at break exhibited a 28% improvement from 14.2 to 18.1% in machine direction.

Example 4: Synthesis of modified biodegradable elastomer with a hydrolyzed biodegradable thermoplastic polyester, made as described under Example 1, as a compatibilizing agent, and then making the blend with modified elastomer and biodegradable thermoplastic polyester using a kneader for injection applications.

Initially, 547 grams of pure glycerol and 878 grams of succinic acid, with a molar ratio of 0.8, were mixed in a 3-liter atmospheric pressure reactor at ambient temperature.

The synthesis reaction was initiated by increasing the temperature through a conventional heater equipped with a temperature controller and then stirred vigorously with two overhead stirrers. The reaction temperature was set to 180° C. One hour after the start of the reaction, 5 wt. % hydrolyzed polylactic acid (PLA) (made as described under embodiment 1) with respect to the total weight of glycerol and succinic acid, was added and the reaction was allowed to proceed for approximately 1.5 hours until gelatinized elastomer was formed. Subsequently, the modified elastomer was allowed to cool to room temperature before further processing.

For the resin blend, 60 wt. % of neat PLA was loaded into a preheated kneader operating at 200° C. and 35 rpm and allowed to completely melt, 40 wt. % of the modified biodegradable elastomer was then added to the molten PLA and blended for an additional 10 minutes under shear and heat. Then the resulting material was extracted from the kneader, cooled to room temperature and crushed into small particles using a crusher. This crushed material was fed into an injection molding machine with a temperature profile of 160 to 180° C., a screw speed of 75 rpm and a mold at room temperature.

The purpose of injection molding was to make ASTM test bars, enabling the evaluation of mechanical properties. The results were compared to similar resin blends made with unmodified elastomer under similar processing conditions. As a result of the enhanced compatibility, a remarkable improvement of 50% from 13.2 to 20.4 MPa and 10% from 24.8 to 27.4 MPa in the stress at break and stress at yield, respectively, were observed. A substantial 77% enhancement in elongation at break from 19.1 to 33.8% and a 13% improvement in flexural modulus from 1377 to 1546 MPa were observed, while the MFI decreased by 40% from 5.8 to 3.5 g/10 min.

Example 5: Synthesis of modified biodegradable elastomer with a hydrolyzed biodegradable thermoplastic polyester, made as described under Example 1, as a compatibilizing agent, and then making the blend with modified elastomer and biodegradable thermoplastic polyester using a kneader for injection applications.

Initially, 547 grams of pure glycerol and 878 grams of succinic acid, with a molar ratio of 0.8, were mixed in a 2-liter atmospheric pressure reactor at ambient temperature.

The synthesis reaction was initiated by increasing the temperature through a conventional heater equipped with a temperature controller and then stirred vigorously with two overhead stirrers. The reaction temperature was set to 180° C. One hour after the start of the reaction, 5 wt. % hydrolyzed polylactic acid (PLA) (made as described under embodiment 1) was added, with respect to the total weight of glycerol and succinic acid The reaction was allowed to proceed for approximately 1.5 hours until gelatinized elastomer was formed. Subsequently, the elastomer was allowed to cool to room temperature before further processing.

For the resin blend, 80 wt. % of neat PLA was loaded into a preheated kneader operating at 190° C. and 35 rpm and allowed to fully melt. 20 wt. % of the modified biodegradable elastomer was added to the molten PLA and blended for a duration of 10 minutes under shear and heat. The resulting material was extracted, cooled to room temperature and crushed into small particles using a crusher. This crushed material was subsequently fed into an injection molding machine with a temperature profile of 160 to 180° C., a screw speed of 75 rpm and a mold at room temperature.

The purpose of injection molding was to make ASTM test bars, enabling the evaluation of mechanical properties. The results were compared to similar resin blends made with unmodified elastomer under similar processing conditions. As a result of the enhanced compatibility, an improvement of 120% in elongation at break from 8.7 to 19.3% and an increase in Young's modulus by 7% from 2635 to 2828 MPa were observed. Furthermore, the MFI decreased by 67% from 89.5 to 29.4 g/10 min as well.

Example 6: Synthesis of modified biodegradable elastomer with a hydrolyzed biodegradable thermoplastic polyester, made as described under Example 1 (but by 5 phr organic acid), as a compatibilizing agent, and then making the blend with modified elastomer and biodegradable thermoplastic polyester using a kneader for film applications.

Initially, 726 grams of pure glycerol and 1034 grams of succinic acid, with a molar ratio of 0.9, were mixed in a 3-liter atmospheric pressure reactor at ambient temperature. 20 wt. % (440 grams) hydrolyzed polylactic acid (HPLA) was added to the mixture, with respect to the total weight of glycerol and succinic acid. The synthesis reaction was initiated by increasing the temperature through a conventional heater equipped with a temperature controller and then stirred vigorously with two overhead stirrers. The reaction temperature was set to 180° C. and allowed to proceed for approximately 2 hours until a gelatinized elastomer was formed. Subsequently, the modified elastomer was allowed to cool to room temperature before further processing.

A 50-50 wt. % master batch of PLA and modified elastomer was produced with a kneader at 190° C. and 35 rpm. The master batch was extracted, cooled, crushed and further processed with a twin screw extruder.

The master batch was used to make a premix with a final composition of 51.9 wt. % PLA, 43.5 wt. % modified elastomer, 4.5 wt. % epoxidized soybean oil (ESO) and 0.1 wt. % processing aid and then blended into pellets using a twin screw extruder with a screw speed of 100 rpm and temperature profile between 130 to 175° C.

The pellets were then fed into a cast film extruder with a temperature profile of 140 to 170° C. and screw speed of 58 rpm to form a film with a thickness of 0.5 mm and a width of 10-12 inches. The film was chilled and pulled via a set of chiller rollers and guiding and winding rollers and finally to before collection.

The biodegradation and disintegration properties of this composition were tested using ASTM D5338 and ASTM D6400 standards. The results showed more than 49% biodegradation within 11 days and a biodegradation of more than 78% within 45 days. Furthermore, disintegration results showed a weight loss of more than 35% within a 60-day period.

The present disclosure has been described using non-limiting detailed descriptions of examples thereof that are not intended to limit the scope of the general inventive concept. It should be understood that features and/or operations described with respect to one example may be used with other examples and that not all examples have all of the features and or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are, replaceable by equivalents, which perform the same function, even if the structure or acts are different, as known in the art. Therefore, the scope of the general inventive concept is limited only by the elements and limitations as used in the claims.

What is claimed is:

1. A hydrolyzed compostable compatibilizer comprising:
about 70 to about 99.99% (w/w) of at least one biodegradable thermoplastic polyester selected from the group consisting of polylactic acid, polycaprolactone, polybutylene succinate, polybutylene succinate adipate, polybutylene succinate terephthalate, polybutylene adipate-co-terephthalate, polyhydroxyalkanoates and a combination thereof; and
about 0.01 to about 30% (w/w) of an organic acid selected from the group consisting of lactic acid, formic acid, stearic acid, tannic acid, malic acid, citric acid, aspartic acid, ascorbic acid, acetic acid, tartaric acid or a combination thereof.

2. A modified biodegradable polyester elastomer comprising
at least one polyol selected from the group consisting of sorbitol, mannitol, galactitol, xylitol, ribitol, arabitol, erythritol, glycerol, threitol and derivatives thereof, and
at least one saturated or unsaturated organic acid selected from the group consisting of succinic acid, sebacic acid, glutaric acid, hexanedioic acid, heptanoic acid, octanedioic acid, nonanedioic acid, and decanoic acid or derivatives thereof,
wherein the molar ratio of polyol to organic acid is about 0.3 to about 1.3;
further comprising about 0.01 to about 50 weight ratio of one or more compostable compatibilizing agents,
wherein the compostable compatibilizing agent comprises
at least one biodegradable thermoplastic polyester selected from polylactic acid, polycaprolactone, polybutylene succinate, polybutylene succinate adipate, polybutylene succinate terephthalate, polybutylene adipate-co-terephthalate, polyhydroxyalkanoates and a combination thereof; and/or
at least one hydrolyzed compostable compatibilizer.

3. A biodegradable resin composition comprising:
about 10 to about 99% (w/w) of a polymer comprising one or more of biodegradable thermoplastic polymers;
about 1 to about 90% (w/w) of modified biodegradable polyester elastomers;
about 0 to about 30% (w/w) of one or more of plasticizers;
about 0 to about 30% (w/w) of one or more of inorganic fillers;
about 0 to about 30% of fiber comprising one or more of biomass.
about 0 to about 10% (w/w) of one or more of additives selected from the group consisting of coupling agents, compatibilizers, chain extenders, processing aids, peroxides, initiators, pigments, and cross-linkers or a combination thereof.

4. The biodegradable resin composition of claim 3, wherein the biodegradable thermoplastic polymer comprises one or more biodegradable thermoplastic polyesters selected from the group consisting of polylactic acid, polycaprolactone, polybutylene succinate, polybutylene succinate adipate, polybutylene succinate terephthalate, polybutylene adipate-co-terephthalate, polyhydroxyalkanoates and a combination thereof.

5. The biodegradable resin composition of claim 3, wherein the plasticizers comprise one or more plant-based oils obtained from vegetables, nuts, grains, seeds, or a combination thereof wherein the oils are one or more plant-based oils selected from corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

6. The biodegradable resin composition of claim 3, wherein the inorganic fillers selected from wollastonite, mica, clay, calcium carbonate, glass fiber, talc, aluminum silicate, zirconium oxide, sepiolite, gypsum and combinations thereof.

7. The biodegradable resin composition of claim 3, wherein the biomass is distillers' grains, vinasse, vinegar residues, wood fiber, virgin starch, modified starch (including thermoplastic starch), agricultural cellulosic matter, straw, stalk, shive, hurd, bast, leaf, seed, fruit, and perennial grass.

8. The biodegradable resin composition of claim 3, wherein the compatibilizer is a hydrolyzed compostable compatibilizer.

9. The biodegradable resin composition of claim 3, comprising a resin of a modified biodegradable polyester elastomer and at least one biodegradable thermoplastic polyester, wherein the composition exhibits enhanced compatibility as evidenced by improved mechanical properties, as compared to a similar composition made with unmodified biodegradable elastomers.

10. The composition of claim 3, wherein the bio-based carbon content of the composition is up to 100%.

11. The composition of claim 3, wherein the composition exhibits more than 75% biodegradation in less than 45 days and more than 60% disintegration in less than 10 days, and under thermophilic temperature conditions.

12. The composition of claim 3, wherein the composition exhibits more than 90% disintegration in less than 84 days and more than 90% biodegradation in less than 180 days under ASTM D6400, and under thermophilic temperature conditions.

13. A method of producing the modified biodegradable polyester elastomer of claim 2 in which the ingredients react at a temperature between about 100 to about 250° C. and continue the reaction until the desired texture of the modified elastomer is achieved.

14. The composition of claim 2, wherein the modified biodegradable polyester elastomer exhibits more than 90% disintegration in less than 84 days and more than 90% biodegradation in less than 180 days under ASTM D6400, and under thermophilic temperature conditions.

15. The method of producing the hydrolyzed compostable compatibilizer of claim 1 in which one or more biodegradable thermoplastic polyesters and one or more organic acids are mixed and melt-compounded together in a polymer processing equipment or apparatus comprising batch mixer, a twin or single screw extruder, and at elevated temperatures for a time period of several seconds to several minutes of from about 2 to about 20 min.

16. The composition of claim 1, wherein the hydrolyzed compostable compatibilizer exhibits more than 90% disintegration in less than 84 days and more than 90% biodegradation in less than 180 days, and under thermophilic temperature conditions.

17. The method of producing the biodegradable resin composition of claim 3 in which ingredients are mixed and melt-compounded together in a polymer processing equipment or apparatus comprising a batch mixer, a or single screw extruder, at elevated temperatures for a time period of several seconds to several minutes.

18. A composition of hydrolyzed compostable compatibilizer of claim 1 where the bio-based carbon content of the compatibilizer is up to 100%.

19. The composition of modified elastomer of claim 2, wherein the bio-based carbon content of the elastomer is up to 100%.

20. The composition of biodegradable resin of claim 3, wherein the bio-based carbon content of the resin is up to 100%.

21. The composition of claim 3 for use in the manufacture of articles using conventional polymer processing techniques comprising blown and cast film extrusion, compression molding, and injection molding techniques.
